(19) United States
(12) Patent Application Publication
(10) Pub. No.: US 2026/0264296 A1
(43) Pub. Date: Sep. 10, 2026

(54) ROUGHENED-FILM PRODUCTION CONTROL METHOD AND SYSTEM

(71) Applicant: ELECTRIC POWER RESEARCH INSTITUTE, CHINA SOUTHERN POWER GRID, Guangzhou, Guangdong (CN)

(72) Inventors: Gang LIU, Guangzhou, Guangdong (CN); Cheng YAO, Guangzhou, Guangdong (CN); Xipeng CAI, Guangzhou, Guangdong (CN); Xipeng CHEN, Guangzhou, Guangdong (CN); Peng WANG, Guangzhou, Guangdong (CN); Kai WANG, Guangzhou, Guangdong (CN); Shangmao HU, Guangzhou, Guangdong (CN); Minchuan LIAO, Guangzhou, Guangdong (CN); Lu QU, Guangzhou, Guangdong (CN); Taishan HU, Guangzhou, Guangdong (CN); Hao LIU, Guangzhou, Guangdong (CN); Qi MEI, Guangzhou, Guangdong (CN); Demin GAO, Guangzhou, Guangdong (CN); Kunxuan WEI, Guangzhou, Guangdong (CN); Long CHEN, Guangzhou, Guangdong (CN)

(73) Assignee: ELECTRIC POWER RESEARCH INSTITUTE, CHINA SOUTHERN POWER GRID, Guangzhou, Guangdong (CN)

(21) Appl. No.: 19/491,391

(22) PCT Filed: Nov. 23, 2023
(86) PCT No.: PCT/CN2023/133556

§ 371 Date: Dec. 9, 2025

(30) Foreign Application Priority Data
Oct. 9, 2023 (CN) 202311298351.0

(51) Int. Cl. B29C 39/44; B29C 39/14; B29L 7/00

(52) U.S. Cl. CPC B29C 39/44; B29C 39/14; B29L 2007/008

(57) ABSTRACT

A roughened-film production control method and system. The method comprises: S1, adjusting a melting temperature such that same is within a range from 230° C. to 240° C., and adjusting the temperature of sheet casting such that same is within a range from 80° C. to 90° C.; S2, measuring the light transmittance of a longitudinally stretched thin film; S3, determining whether the light transmittance of the thin film is within a preset range; S4, if the light transmittance of the thin film is within the preset range, keeping the current melting temperature and the temperature of the sheet casting unchanged; and S5, if the light transmittance of the thin film is not within the preset range, adjusting, on the basis of the magnitude of the light transmittance of the thin film, the melting temperature and the temperature of the sheet casting according to a preset step length, and returning back to step S2.

This application claims priority to Chinese Patent Application No. 202311298351.0, titled “ROUGHENED-FILM PRODUCTION AND CONTROL METHOD AND SYSTEM”, filed on Oct. 9, 2023 with the China National Intellectual Property Administration, which is incorporated herein by reference in its entirety.

### FIELD

The present disclosure relates to the technical field of roughened film production processes, and in particular to a roughened film production and control method and a roughened film production and control system.

### BACKGROUND

Biaxially-oriented polypropylene roughened films are primary solid dielectric material for high-voltage oil-impregnated capacitors and are widely used. Porosity and surface roughness are important index parameters for roughened films. In a case of small porosity and insufficient surface roughness, the impregnation agent of the capacitor cannot enter between films, resulting in insufficient voltage resistance and rapid aging of the capacitor.

The degree of surface roughness of the roughened films is related to parameters such as the molecular weight distribution and the isotactic index of the polypropylene raw material. It is usually difficult to maintain the molecular weight distribution and the isotactic index of the polymer materials unchanged during a polymerization process, especially for materials produced by different manufacturers, of which there may be significant differences in molecular weight distribution and isotactic index. In the conventional roughened film drawing process, testing is performed after film drawing based on previous processing experience. In a case that the surface roughness meets requirements, production is performed continuously; and in a case that the surface roughness does not meet requirements, temperature is adjusted during the film drawing until the surface roughness of the film meets the requirements. For the production of roughened films based on single-source materials, temperature adjustment may be performed based on experience to meet surface roughness requirements for films. However, in a case that the materials of the roughened films are replaced, the original experience for the roughened film drawing process is inapplicable, and then it is required to perform another lengthy procedure. That is, testing is performed after film drawing, production is performed continuously in the case that the surface roughness meets requirements, and temperature is adjusted during the film drawing until the surface roughness of the film meets the requirements in the case of the surface roughness not meeting requirements, resulting in low efficiency and material waste. Therefore, how to design a roughened film production process suitable for various roughened film materials to improve roughened film production efficiency and reduce material waste is an issue to be solved urgently by those skilled in the art.

### SUMMARY

A roughened film production and control method and a roughened film production and control system are provided according to the present disclosure, to solve the technical problems of it being difficult to apply the conventional roughened film drawing process to various roughened film materials, resulting in low efficiency and material waste.

In view of this, a roughened film production and control method is provided according to a first aspect of the present disclosure. The method includes:
step S1: adjusting a melting temperature to a range from 230° C. to 240° C. and adjusting a casting temperature to a range from 80° C. to 90° C.;
step S2: measuring a light transmittance of a film longitudinally stretched;
step S3: determining whether the light transmittance is within a predetermined range;
step S4: maintaining the melting temperature and the casting temperature unchanged in a case that the light transmittance is within the predetermined range; and
step S5: adjusting the melting temperature and the casting temperature by a predetermined step size based on the light transmittance, and proceeding to step S2, in a case that the light transmittance is not within the predetermined range.

In an embodiment, the predetermined range is 40% to 60%.

In an embodiment, the step S5 includes:
determining whether the light transmittance is less than a lower limit of the predetermined range;
increasing the melting temperature and the casting temperature by the predetermined step size, and proceeding to the step S2, in a case that the light transmittance is less than the lower limit of the predetermined range; and
decreasing the melting temperature and the casting temperature by the predetermined step size, and proceeding to the step S2, in a case that the light transmittance is not less than the lower limit of the predetermined range.

In an embodiment, the step S5 includes:
determining whether the light transmittance is greater than an upper limit of the predetermined range;
decreasing the melting temperature and the casting temperature by the predetermined step size, and proceeding to the step S2, in a case that the light transmittance is greater than the upper limit of the predetermined range; and
increasing the melting temperature and the casting temperature by the predetermined step size, and proceeding to the step S2, in a case that the light transmittance is not greater than the upper limit of the predetermined range.

In an embodiment, the step S2 includes:
step S2-1: starting a longitudinal stretching process;
step S2-2: measuring a light flux of the film by using a light flux measurement device, where the light flux measurement device includes a light source, an upper condenser lens, a lower condenser lens, an upper modulator, a lower modulator, an upper objective lens, a lower objective lens, an upper integrating sphere, a lower integrating sphere, an upper photometer and a lower photometer, the upper integrating sphere is arranged above and adjacent to the film, the upper objective lens, the upper modulator, the upper condenser lens, the light source, the lower condenser lens, the lower modulator, the lower objective lens and the lower integrating sphere are arranged sequentially from top to bottom below the film, the upper photometer outputs a light flux of the upper integrating sphere, and the lower photometer outputs a light flux of the lower integrating sphere; and step S2-3: calculating the light transmittance based on the light flux of the upper integrating sphere and the light flux of the lower integrating sphere.

In an embodiment, the predetermined step size ranges from 1 k to 5 k.

A roughened film production and control system is provided according to a second aspect of the present disclosure. The system includes a temperature initialization module, a film light transmittance measurement module, a determination module, a first control module, and a second control module.

The temperature initialization module is configured to adjust a melting temperature to a range from 230° C. to 240° C. and adjust a casting temperature to a range from 80° C. to 90° C.

The film light transmittance measurement module is configured to measure a light transmittance of a film longitudinally stretched.

The determination module is configured to determine whether the light transmittance is within a predetermined range.

The first control module is configured to maintain the melting temperature and the casting temperature unchanged in a case that the light transmittance is within the predetermined range.

The second control module is configured to adjust the melting temperature and the casting temperature by a predetermined step size based on the light transmittance, and trigger the film light transmittance measurement module to perform measurement, in a case that the light transmittance is not within the predetermined range.

In an embodiment, the second control module is further configured to:
determine whether the light transmittance is less than a lower limit of the predetermined range; increase the melting temperature and the casting temperature by the predetermined step size, and trigger the film light transmittance measurement module to perform measurement, in a case that the light transmittance is less than the lower limit of the predetermined range; and decrease the melting temperature and the casting temperature by the predetermined step size, and trigger the film light transmittance measurement module to perform measurement, in a case that the light transmittance is not less than the lower limit of the predetermined range; or
determine whether the light transmittance is greater than an upper limit of the predetermined range; decrease the melting temperature and the casting temperature by the predetermined step size, and trigger the film light transmittance measurement module to perform measurement, in a case that the light transmittance is greater than the upper limit of the predetermined range; and increase the melting temperature and the casting temperature by the predetermined step size, and trigger the film light transmittance measurement module to perform measurement, in a case that the light transmittance is not greater than the upper limit of the predetermined range.

In an embodiment, the film light transmittance measurement module includes: a longitudinal stretch starting submodule, a light flux measurement submodule, and a light transmittance calculation submodule.

The longitudinal stretch starting submodule is configured to start a longitudinal stretching process.

The light flux measurement submodule is configured to measure a light flux of the film by using a light flux measurement device. The light flux measurement device includes a light source, an upper condenser lens, a lower condenser lens, an upper modulator, a lower modulator, an upper objective lens, a lower objective lens, an upper integrating sphere, a lower integrating sphere, an upper photometer and a lower photometer. The upper integrating sphere is arranged above and adjacent to the film, the upper objective lens. The upper modulator, the upper condenser lens, the light source, the lower condenser lens, the lower modulator, the lower objective lens and the lower integrating sphere are arranged sequentially from top to bottom below the film. The upper photometer outputs a light flux of the upper integrating sphere, and the lower photometer outputs a light flux of the lower integrating sphere.

The light transmittance calculation submodule is configured to calculate the light transmittance based on the light flux of the upper integrating sphere and the light flux of the lower integrating sphere.

From the above technical solutions, it can be seen that the roughened film production and control method according to the present disclosure has the following advantages.

With the roughened film production and control method according to the present disclosure, the film temperature of the longitudinally stretched films is tested online, and the temperature is controlled during the melting stage and the casting stage, so that the surface roughness and the porosity of the capacitor film are continuously controlled, and the effectiveness and material loss caused by offline control are reduced, thereby solving the technical problems of it being difficult to apply the conventional roughened film drawing process to various roughened film materials, with low efficiency and material waste.

### BRIEF DESCRIPTION OF THE DRAWINGS

In order to clearly illustrate the technical solutions in the embodiments of the present disclosure or in the conventional technology, the drawings to be used in the description of the embodiments or the conventional technology are briefly described below. It is apparent that the drawings in the following description show only some embodiments of the present disclosure, and other drawings may be obtained by those skilled in the art from the drawings without any creative work.

FIG. 1 is a flowchart of a roughened film production and control method according to the present disclosure;

FIG. 2 is a flowchart of a roughened film production and control method according to an embodiment of the present disclosure;

FIG. 3 is a flowchart of a roughened film production and control method according to another embodiment of the present disclosure;

FIG. 4 is a schematic diagram showing a structure and an installation position of a light flux measurement device according to the present disclosure; and

FIG. 5 is a schematic structural diagram of a roughened film production and control system according to the present disclosure.

### DETAILED DESCRIPTION OF THE EMBODIMENTS

To enable those skilled in the art to understand the solutions according to the present disclosure, the technical solutions in the embodiments of the present disclosure are described clearly and completely hereinafter with reference to the drawings in the embodiments of the present disclosure. It is apparent that the embodiments described are only some rather than all the embodiments of the present disclosure. All other embodiments obtained by those skilled in the art based on the embodiments in the present disclosure without any creative work fall within the protection scope of the present disclosure.

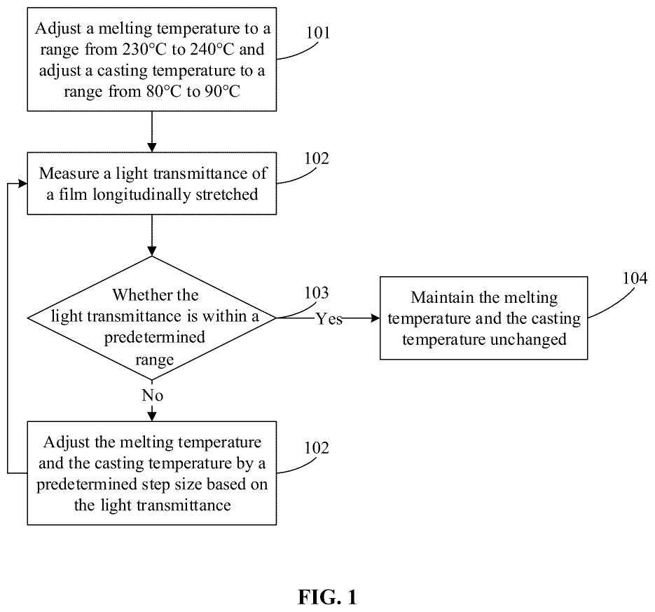

For ease of understanding, referring to FIG. 1, a roughened film production and control method is provided according to an embodiment of the present disclosure. The method includes the following steps 101 to 105.

In step 101, a melting temperature is adjusted to a range from 230° C. to 240° C., and a casting temperature is adjusted to a range from 80° C. to 90° C.

It should be noted that the β crystal content and grain (spherulite) morphology of the casting are closely related to the micropores and cavitation of the film, and the formed skin-core layered structure and transverse grains in the skin layer are important causes of surface roughening of films. However, according to the electrical performance requirements of roughened films, it is not allowed to change grain shapes by using β nucleating agents to improve the surface roughening morphology. The crystallinity, homogeneous polycrystalline state, crystalline morphology, crystal structure, skin-core structure and the like of the casting are all formed during the transition from a melting state to an super-cooled state, and it is required to effectively control these structural factors to control the surface roughening. A film stretching process includes a melting process, a casting process, a longitudinal stretching process, a transverse stretching process, and other processes. The important factors affecting the β crystal parameters are the temperatures during the melting process and the casting process. In the embodiment of the present disclosure, the melting temperature is adjusted to a range from 230° C. to 240° C., and the casting temperature is adjusted to a range from 80° C. to 90° C.

In step 102, a light transmittance of a film longitudinally stretched is measured.

It should be noted that stretching and roughening of the film mainly depends on the content and distribution of the β crystals in the film. The β crystals are regulated or generated during the melting process to the cooling process, and many β crystals are generated in increasing the temperature of the casting (a thicker film placed on a cold drum after melting is referred to as a casting). That is, the β crystals may be regulated in the melting process and the cooling process, and cannot be regulated later. In the transverse stretching process, the β crystals are converted to a crystals, and it is difficult to perform controlling with a too small light transmittance range. In the longitudinal stretching process, the film still contains a large number of β crystals, and it is easy to perform regulation and controlling with a light transmittance changing in a large range. Therefore, in the embodiment of the present disclosure, after the film is longitudinally stretched in the longitudinal stretching process, the light transmittance of the longitudinally stretched film is measured.

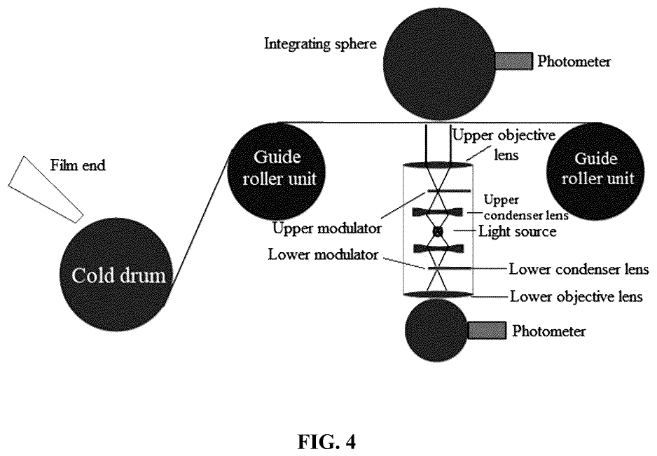

In an embodiment, the light transmittance may be measured by using a light flux measurement device. As shown in FIG. 4, the light flux measurement device includes a light source, an upper condenser lens, a lower condenser lens, an upper modulator, a lower modulator, an upper objective lens, a lower objective lens, an upper integrating sphere, a lower integrating sphere, an upper photometer, and a lower photometer. The upper integrating sphere is arranged above and adjacent to the film. The upper objective lens, the upper modulator, the upper condenser lens, the light source, the lower condenser lens, the lower modulator, the lower objective lens and the lower integrating sphere are arranged sequentially from top to bottom below the film. The upper photometer outputs a light flux of the upper integrating sphere, and the lower photometer outputs a light flux of the lower integrating sphere. The light transmittance is calculated based on the light flux of the upper integrating sphere and the light flux of the lower integrating sphere. The light source is a halogen tungsten lamp. T1 represents the light flux of the upper integrating sphere outputted by the upper photometer, T2 represents the light flux of the lower integrating sphere outputted by the lower photometer, and T1/T2 represents the light transmittance. T1=T2=(P1×t1−P0)/t, where P1 represents a light flux of a modulator (where T1 corresponds to the upper modulator and T2 corresponds to the lower modulator) in a case of light penetrating, P0 represents a light flux of the modulator (where T1 corresponds to the upper modulator and T2 corresponds to the lower modulator) in a case of no light penetrating, t represents a time period of the modulator (where T1 corresponds to the upper modulator and T2 corresponds to the lower modulator), and t1 represents a time duration of light passing through the modulator (where T1 corresponds to the upper modulator and T2 corresponds to the lower modulator).

In step 103, it is determined whether the light transmittance is within a predetermined range.

It should be noted that in the embodiments of the present disclosure, after measuring the light transmittance of the film longitudinally stretched, it is required to determine whether the light transmittance is within a predetermined range. In an embodiment, the predetermined range is 40% to 60%. The light transmittance is related to the roughening degree of the surface in subsequent stages. A higher light transmittance indicates a smoother surface in subsequent stages, and a lower light transmittance indicates a rougher surface in subsequent stages. Generally, a capacitor has a multi-layer structure. For a surface that is too smooth, it is not conducive for oil to enter between two layers of medias; and for a surface that is too rough, too many weaknesses exist and it is not conducive to voltage resistance. For a film having identical average thickness and a high roughness, some positions on the film there may have low thickness and are prone to be broken down. However, if the surface is too smooth, no grooves exist between two films for oil to enter, and the film with internal gaps are prone to be broken down. With the range of 40% to 60%, a standard requirement of 9%±3% may be met.

In step 104, in a case that the light transmittance is within the predetermined range, the melting temperature and the casting temperature are maintained unchanged.

In step 105, in a case that the light transmittance is not within the predetermined range, the melting temperature and the casting temperature are adjusted by a predetermined step size based on the light transmittance, and proceed to step 102.

It should be noted that in a case that the light transmittance is within the predetermined range, it indicates that the melting temperature and the casting temperature meet the requirements, and the current melting temperature and the current casting temperature may be maintained unchanged; and in a case that the light transmittance is not within the predetermined range, the melting temperature and the casting temperature are adjusted by a predetermined step size based on the light transmittance, and proceed to the step 102 to measure the light transmittance until the light transmittance is within the predetermined range. In a case of excessive temperature adjustment, it may result in over-adjustment and prolong the adjustment process, and the cold drum and the device used for the melting process both having large structures and significant thermal inertias cannot be adjusted with temperature differences in a short time period. Therefore, the predetermined step size for adjusting the melting temperature and the casting temperature ranges between 1 k to 5 k in the embodiment of the present disclosure.

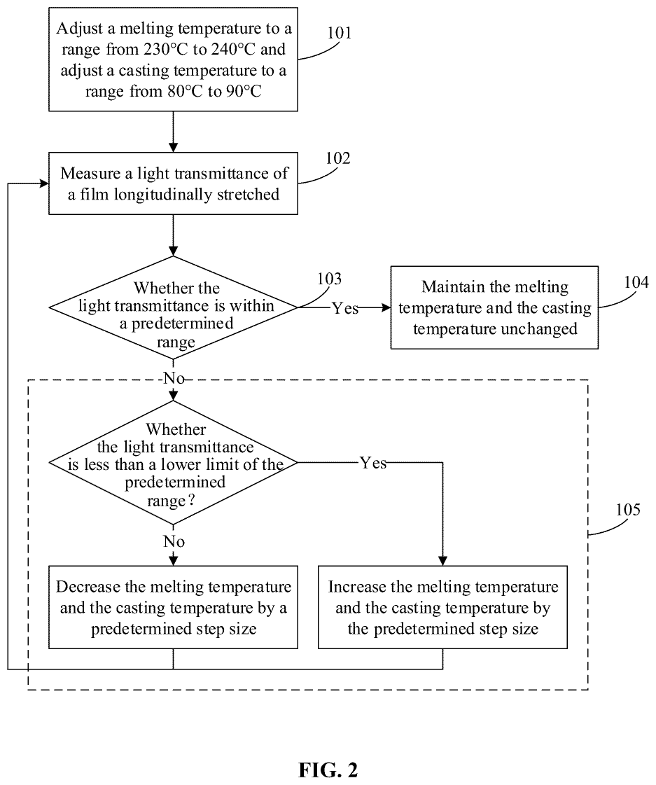

In an embodiment, as shown in FIG. 2, in the case that the light transmittance is not within the predetermined range, it is required to determine whether the light transmittance is less than a lower limit of the predetermined range. In a case that the light transmittance is less than the lower limit of the predetermined range, the melting temperature and the casting temperature are increased by the predetermined step size, and proceed to the step S2. In a case that the light transmittance is not less than the lower limit of the predetermined range, the melting temperature and the casting temperature are decreased by the predetermined step size, and proceed to the step S2.

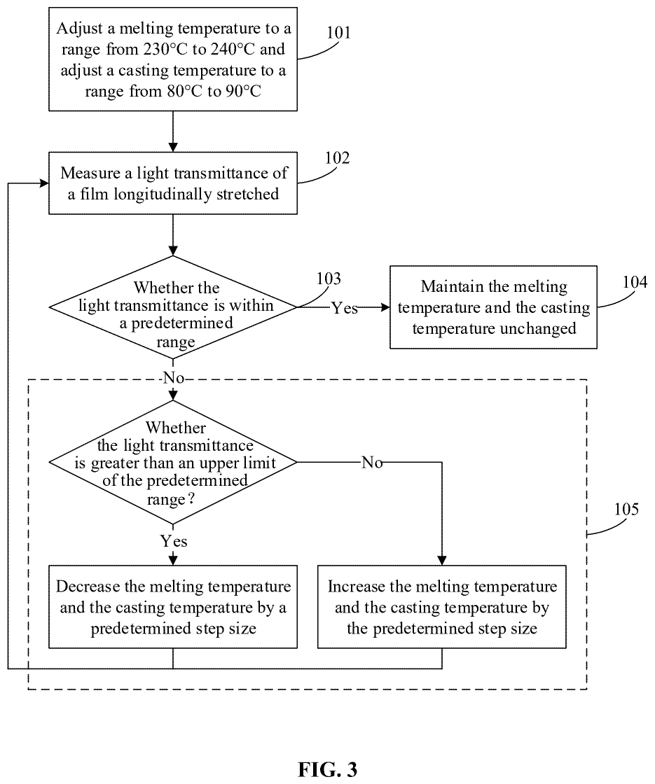

In an embodiment, as shown in FIG. 3, in the case that the light transmittance is not within the predetermined range, it is required to determine whether the light transmittance is greater than an upper limit of the predetermined range. In a case that the light transmittance is greater than the upper limit of the predetermined range, the melting temperature and the casting temperature are decreased by the predetermined step size, and proceed to the step S2. In a case that the light transmittance is not greater than the upper limit of the predetermined range, the melting temperature and the casting temperature are increased by the predetermined step size, and proceed to the step S2.

With the roughened film production and control method according to the present disclosure, the film temperature of the longitudinally stretched films is tested online, and the temperature is controlled during the melting stage and the casting stage, so that the surface roughness and the porosity of the capacitor film are continuously controlled, and the effectiveness and material loss caused by offline control are reduced, thereby solving the technical problems of it being difficult to apply the conventional roughened film drawing process to various roughened film materials, with low efficiency and material waste.

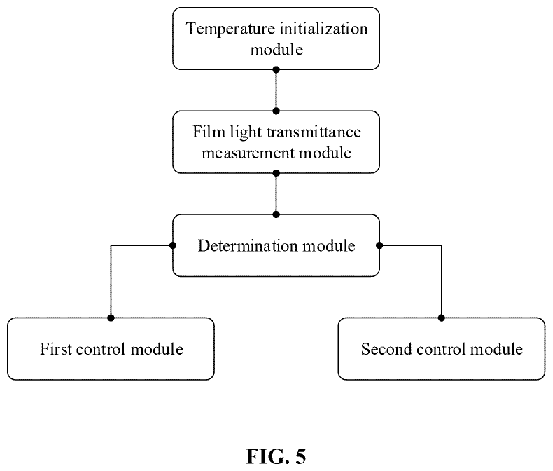

For ease of understanding, referring to FIG. 5, a roughened film production and control system is provided according to an embodiment of the present disclosure. The system includes: a temperature initialization module, a film light transmittance measurement module, a determination module, a first control module, and a second control module.

The temperature initialization module is configured to adjust a melting temperature to a range from 230° C. to 240° C. and adjust a casting temperature to a range from 80° C. to 90° C.

The film light transmittance measurement module is configured to measure a light transmittance of a film longitudinally stretched.

The determination module is configured to determine whether the light transmittance is within a predetermined range.

The first control module is configured to maintain the melting temperature and the casting temperature unchanged in a case that the light transmittance is within the predetermined range.

The second control module is configured to adjust the melting temperature and the casting temperature by a predetermined step size based on the light transmittance, and trigger the film light transmittance measurement module to perform measurement, in a case that the light transmittance is not within the predetermined range.

The predetermined range is 40% to 60%.

The second control module is further configured to: determine whether the light transmittance is less than a lower limit of the predetermined range; increase the melting temperature and the casting temperature by the predetermined step size, and trigger the film light transmittance measurement module to perform measurement, in a case that the light transmittance is less than the lower limit of the predetermined range; and decrease the melting temperature and the casting temperature by the predetermined step size, and trigger the film light transmittance measurement module to perform measurement, in a case that the light transmittance is not less than the lower limit of the predetermined range; or determine whether the light transmittance is greater than an upper limit of the predetermined range; decrease the melting temperature and the casting temperature by the predetermined step size, and trigger the film light transmittance measurement module to perform measurement, in a case that the light transmittance is greater than the upper limit of the predetermined range; and increase the melting temperature and the casting temperature by the predetermined step size, and trigger the film light transmittance measurement module to perform measurement, in a case that the light transmittance is not greater than the upper limit of the predetermined range.

The film light transmittance measurement module includes: a longitudinal stretch starting submodule, a light flux measurement submodule, and a light transmittance calculation submodule.

The longitudinal stretch starting submodule is configured to start a longitudinal stretching process.

The light flux measurement submodule is configured to measure a light flux of the film by using a light flux measurement device. The light flux measurement device includes a light source, an upper condenser lens, a lower condenser lens, an upper modulator, a lower modulator, an upper objective lens, a lower objective lens, an upper integrating sphere, a lower integrating sphere, an upper photometer and a lower photometer. The upper integrating sphere is arranged above and adjacent to the film, the upper objective lens. The upper modulator, the upper condenser lens, the light source, the lower condenser lens, the lower modulator, the lower objective lens and the lower integrating sphere are arranged sequentially from top to bottom below the film. The upper photometer outputs a light flux of the upper integrating sphere, and the lower photometer outputs a light flux of the lower integrating sphere.

The light transmittance calculation submodule is configured to calculate the light transmittance based on the light flux of the upper integrating sphere and the light flux of the lower integrating sphere.

The predetermined step size ranges from 1 k to 5 k.

The roughened film production and control system according to the present disclosure is configured to perform the roughened film production and control method according to the present disclosure, and the principle and the technical effects achieved by the roughened film production and control system are identical to those of the roughened film production and control method according to the present disclosure, and are not repeated herein.

As described above, the above embodiments are only intended to describe the technical solutions of the present disclosure, and not to limit the present disclosure. Although the present disclosure is described in detail with reference to the above embodiments, those skilled in the art should understand that, modifications may be made to the technical solutions described in the above embodiments, or equivalent replacements may be made to some of the technical features in the above embodiments. These modifications and replacements do not make the corresponding technical solutions deviate from the spirit and the scope of the technical solutions in the embodiments of the present disclosure.

1. A roughened film production and control method, comprising:
step S1: adjusting a melting temperature to a range from 230° C. to 240° C. and adjusting a casting temperature to a range from 80° C. to 90° C.;
step S2: measuring a light transmittance of a film longitudinally stretched;
step S3: determining whether the light transmittance is within a predetermined range;
step S4: maintaining the melting temperature and the casting temperature unchanged in a case that the light transmittance is within the predetermined range; and
step S5: adjusting the melting temperature and the casting temperature by a predetermined step size based on the light transmittance, and proceeding to step S2, in a case that the light transmittance is not within the predetermined range.

2. The roughened film production and control method according to claim 1, wherein the predetermined range is 40% to 60%.

3. The roughened film production and control method according to claim 1, wherein the step S5 comprises:
determining whether the light transmittance is less than a lower limit of the predetermined range;
increasing the melting temperature and the casting temperature by the predetermined step size, and proceeding to the step S2, in a case that the light transmittance is less than the lower limit of the predetermined range; and
decreasing the melting temperature and the casting temperature by the predetermined step size, and proceeding to the step S2, in a case that the light transmittance is not less than the lower limit of the predetermined range.

4. The roughened film production and control method according to claim 1, wherein the
determining whether the light transmittance is greater than an upper limit of the predetermined range;
decreasing the melting temperature and the casting temperature by the predetermined step size, and proceeding to the step S2, in a case that the light transmittance is greater than the upper limit of the predetermined range; and
increasing the melting temperature and the casting temperature by the predetermined step size, and proceeding to the step S2, in a case that the light transmittance is not greater than the upper limit of the predetermined range.

5. The roughened film production and control method according to claim 1, wherein the step S2 comprises:
step S2-1: starting a longitudinal stretching process;
step S2-2: measuring a light flux of the film by using a light flux measurement device, wherein the light flux measurement device comprises a light source, an upper condenser lens, a lower condenser lens, an upper modulator, a lower modulator, an upper objective lens, a lower objective lens, an upper integrating sphere, a lower integrating sphere, an upper photometer and a lower photometer, the upper integrating sphere is arranged above and adjacent to the film, the upper objective lens, the upper modulator, the upper condenser lens, the light source, the lower condenser lens, the lower modulator, the lower objective lens and the lower integrating sphere are arranged sequentially from top to bottom below the film, the upper photometer outputs a light flux of the upper integrating sphere, and the lower photometer outputs a light flux of the lower integrating sphere; and
step S2-3: calculating the light transmittance based on the light flux of the upper integrating sphere and the light flux of the lower integrating sphere.

6. The roughened film production and control method according to claim 5, wherein the predetermined step size ranges from 1 k to 5 k.

7. A roughened film production and control system, comprising:
a temperature initialization module, configured to adjust a melting temperature to a range from 230° C. to 240° C. and adjust a casting temperature to a range from 80° C. to 90° C.;
a film light transmittance measurement module, configured to measure a light transmittance of a film longitudinally stretched;
a determination module, configured to determine whether the light transmittance is within a predetermined range;
a first control module, configured to maintain the melting temperature and the casting temperature unchanged in a case that the light transmittance is within the predetermined range; and
a second control module, configured to adjust the melting temperature and the casting temperature by a predetermined step size based on the light transmittance, and trigger the film light transmittance measurement module to perform measurement, in a case that the light transmittance is not within the predetermined range.

8. The roughened film production and control system according to claim 7, wherein the predetermined range is 40% to 60%.

9. The roughened film production and control system according to claim 7, wherein the second control module is further configured to:
determine whether the light transmittance is less than a lower limit of the predetermined range; increase the melting temperature and the casting temperature by the predetermined step size, and trigger the film light transmittance measurement module to perform measurement, in a case that the light transmittance is less than the lower limit of the predetermined range; and decrease the melting temperature and the casting temperature by the predetermined step size, and trigger the film light transmittance measurement module to perform measurement, in a case that the light transmittance is not less than the lower limit of the predetermined range; or
determine whether the light transmittance is greater than an upper limit of the predetermined range; decrease the melting temperature and the casting temperature by the predetermined step size, and trigger the film light transmittance measurement module to perform measurement, in a case that the light transmittance is greater than the upper limit of the predetermined range; and increase the melting temperature and the casting temperature by the predetermined step size, and trigger the film light transmittance measurement module to perform measurement, in a case that the light transmittance is not greater than the upper limit of the predetermined range.

10. The roughened film production and control system according to claim 7, wherein the film light transmittance measurement module comprises:
a longitudinal stretch starting submodule, configured to start a longitudinal stretching process;
a light flux measurement submodule, configured to measure a light flux of the film by using a light flux measurement device, wherein the light flux measurement device comprises a light source, an upper condenser lens, a lower condenser lens, an upper modulator, a lower modulator, an upper objective lens, a lower objective lens, an upper integrating sphere, a lower integrating sphere, an upper photometer and a lower photometer, the upper integrating sphere is arranged above and adjacent to the film, the upper objective lens, the upper modulator, the upper condenser lens, the light source, the lower condenser lens, the lower modulator, the lower objective lens and the lower integrating sphere are arranged sequentially from top to bottom below the film, the upper photometer outputs a light flux of the upper integrating sphere, and the lower photometer outputs a light flux of the lower integrating sphere; and
a light transmittance calculation submodule, configured to calculate the light transmittance based on the light flux of the upper integrating sphere and the light flux of the lower integrating sphere.
